(19) United States
(12) Patent Application Publication
(10) Pub. No.: US 2025/0142478 A1
(43) Pub. Date: May 1, 2025

(54) CHANNEL STATE INFORMATION REPORTING IN LOW-POWER WAKE-UP RADIO WIRELESS COMMUNICATION

(71) Applicant: Lenovo (Singapore) Pte. Limited, Singapore (SG)

(72) Inventors: Shwetha Sreejith, Steinbach (DE); Joachim Löhr, Wiesbaden (DE); Prateek Basu Mallick, Dreieich (DE); Karthikeyan Ganesan, Kronberg (DE)

(21) Appl. No.: 18/932,485

(22) Filed: Oct. 30, 2024

Related U.S. Application Data
(60) Provisional application No. 63/595,330, filed on Nov. 1, 2023.

(51) Int. Cl. H04W 52/02; H04B 7/06; H04W 72/1268; H04W 72/231

(52) U.S. Cl. CPC H04W 52/0235; H04B 7/0626; H04W 72/1268; H04W 72/231

(57) ABSTRACT

Various aspects of the present disclosure relate to a user equipment (UE) for wireless communication. The UE includes a transceiver including a main radio and a low power wake-up radio, at least one memory, and at least one processor coupled to the transceiver and the at least one memory. The at least one processor is configured to cause the UE to, in response to configuring use of the low-power wake-up radio of the transceiver, initiate monitoring of a downlink from a network equipment for a low-power wake-up signal using the low power radio. The UE receives a wake-up indication within the LP-WUS. The UE is configured to identify from the wake-up indication whether the main radio (MR) needs to be woken up, and to identify from the LP-WUS whether channel state information needs to be reported, based at least on one or more channel state information reporting conditions and/or configurations.

### PRIORITY CLAIM

The present application claims priority from U.S. provisional application No. 63/595,330, filed on Nov. 1, 2023, the entire content of which is incorporated herein.

### TECHNICAL FIELD

The present disclosure relates to wireless communications, and more specifically to channel state information reporting in support of wireless communications.

### BACKGROUND

A wireless communications system may include one or multiple network communication devices, such as base stations, that may support wireless communications for one or multiple user communication devices, which are also called user equipment (UE) or other suitable terminology. The wireless communications system may support wireless communications with one or multiple user communication devices by utilizing resources of the wireless communications system, including time resources (e.g., symbols, slots, subframes, frames, or the like) or frequency resources (e.g., subcarriers, carriers, or the like). Additionally, the wireless communications system may support wireless communications across various radio access technologies, such as third generation (3G) radio access technology, fourth generation (4G) radio access technology, fifth generation (5G) radio access technology, and other suitable radio access technologies beyond 5G (e.g., sixth generation (6G)).

### SUMMARY

Some implementations of the method and apparatuses described herein may include performing wireless communications at a user equipment (UE) that reduces occasions of channel state information (CSI) reporting to save device power while using a low-power wake-up radio (LP-WUR). The reduction of CSI reporting does not necessarily eliminate all occasions for CSI reporting, in order to retain the benefits for successful wireless communication coverage for the UE. The UE has a transceiver that includes a main radio and a low power radio and at least one memory. The UE includes at least one processor coupled with the transceiver and the at least one memory. The at least one processor is configured to cause the user equipment to, in response to configuring the low power radio for use as a low-power wake-up radio of the transceiver, initiate monitoring of a downlink from a network equipment for a low-power wake-up signal using the low power radio. The transceiver of the UE receives a configuration for at least one channel state information transmit condition of the user equipment. In response to identifying that the channel state information transmit condition is not satisfied, the at least one processor configures the UE to continue monitoring the downlink for the low-power wake-up signal using the low power radio and does not wake up the main radio.

In some implementations of the method and apparatuses described herein, a network equipment supports performing wireless communication at the UE that reduces occasions of CSI reporting to save power while using the LP-WUR. The network equipment connects, via a transceiver, to a UE having a low-power wake-up radio and a main radio. The network equipment configures the user equipment to monitor for a low-power wake-up signal, using the low power radio, to wake up the main radio. The network equipment receives user equipment assistance information associated with the user equipment, which may include one or more of stored power, a mobility rate, and power coverage. The network equipment compares the user equipment assistance information to a corresponding one or more criterion threshold of the at least one criterion to determine whether the user equipment satisfies the at least one criterion for reduced reporting of channel state information. The network equipment configures the user equipment with at least one channel state information transmit condition.

As utilized herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

### BRIEF DESCRIPTION OF THE DRAWINGS

FIG. 1 illustrates an example of a wireless communications system in accordance with aspects of the present disclosure.

FIG. 2 is a timing diagram of periodic reporting with reduced reporting of channel state information for low-power wake-up radio (LP-WUR) mode in accordance with aspects of the present disclosure.

FIG. 3 is a timing diagram of aperiodic reporting with reduced reporting of channel state information for LP-WUR mode in accordance with aspects of the present disclosure.

FIG. 4 is a timing diagram of semi-persistent reporting with reduced reporting of channel state information for LP-WUR mode in accordance with aspects of the present disclosure.

FIG. 5 presents example Syntax 1.1 for downlink control information for power saving (DCP) information element that incorporates a new parameter for LP-WUR mode in accordance with aspects of the present disclosure.

FIG. 6 is example Syntax 1.2 for a new information element for LP-WUR mode in accordance with aspects of the present disclosure.

FIG. 7 is a diagram of communication activity for channel state information (CSI) reporting by a main radio and a lower power radio of a UE configured for LP-WUR mode, in accordance with aspects of the present disclosure.

FIGS. 8A-8H (collectively “FIG. 8”) are Syntax 3.1 that introduces a new radio resource control (RRC) parameter to limit how often the periodic CSI report is transmitted in accordance with aspects of the present disclosure.

FIG. 9 presents example Syntax 4.1 for RRC connected mode including optional Boolean parameters that control LP-WUR mode in accordance with aspects of the present disclosure.

FIGS. 10A-10C (collectively “FIG. 10”) present example Syntax 5.1 for an information element that carries explicit CSI reporting information in addition to physical downlink control channel (PDCCH) monitoring/skipping information, in accordance with aspects of the present disclosure.

FIG. 11 illustrates an example of a user equipment (UE) in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrate a flowchart of a method performed by a UE in accordance with aspects of the present disclosure.

FIG. 15 illustrate a flowchart of a method performed by an NE in accordance with aspects of the present disclosure.

### DETAILED DESCRIPTION

Channel state information (CSI) is reported by a receiving device (e.g., a user equipment (UE)) to enable a transmitting device (e.g., a network entity (NE)) to adjust transmission parameters to compensate for atmospheric propagation conditions in order to achieve successful communication with the receiving device.

Interest exists for further defining the air interface for current fifth-generation (5G) new radio (NR) telecommunication standards to address low-power wake-up signal (LP WUS). In particular, further definition is primarily needed for low-power wake-up signal (LP-WUS) and low-power wake-up radio (LR) for power-sensitive, small form-factor devices including Internet of Things (IoT) use cases (e.g., industrial sensors, controllers) and wearables. Other use cases are not precluded (e.g., extended reality (XR) device, smart glasses, and smart phones).

Currently, one main radio (MR) in the UE is responsible for attaining service from the serving radio network (gNB). With the intended design of a new LP-WUR, the UE should offload some of its MR functionalities from MR to the LR to conserve power. The LR uses a newly designed low-power signal, also known as the low-power wake up signal (LP-WUS) giving the LR the advantage of low power consumption, but this comes at a cost of reduced coverage of the LR as compared to the coverage of the MR.

At present, the UE reports CSI measurements in the uplink (UL) to provide the network with information about the channel, as measured by the UE. Conventionally, for an LR capable UE, the MR needs to be woken up for any UL transmissions. When the LR is configured and LP-WUS is activated or enabled, this constant reporting of CSI measurements may adversely affect the power saving gain of using the LR since the MR would need to wake up every time a report needs to be transmitted.

Furthermore, when RRC connected mode discontinuous reception (DRX) is configured, the UE also transmits CSI Reports as per the following conditions:
(i) if the Long DRX cycle is used for a DRX group, and [(system frame number (SFN)×10)+subframe number] modulo (drx-LongCycle)=drx-StartOffset;
(ii) if downlink control information (DCI) format 2_6 with cyclic redundancy checks (CRC) scrambled by power saving radio network temporary identifier (PS-RNTI) downlink control information for power saving (DCP) monitoring is configured for the active downlink (DL) bandwidth parts (BWP) as specified;
(iii) if DCP indication associated with the current DRX cycle received from lower layer indicated to start drx-onDurationTimer, as specified; OR if all DCP occasion(s) in time domain, as specified, associated with the current DRX cycle occurred in active time considering grants, assignments, DRX command MAC CE, Long DRX Command MAC CE received and scheduling request sent until 4-ms prior to start of the last DCP occasion, or during a measurement gap, or when the MAC entity monitors for a physical downlink control channel (PDCCH) transmission on the search space indicated by “recoverySearchSpaceId” of the special cell (SpCell) identified by the cell radio network temporary identifier (C-RNTI) while the “ra-Response Window” is running as specified; OR if “ps-Wakeup” is configured with value true and DCP indication associated with the current DRX cycle has not been received from lower layers;
(iv) start “drx-onDurationTimer” after “drx-SlotOffset” from the beginning of the subframe.

Alternatively, the UE also transmits CSI Reports as per the following conditions:
(i) if DCP monitoring is configured for the active DL BWP as specified; AND if the current symbol n occurs within “drx-onDurationTimer” duration; AND if drx-onDurationTimer associated with the current DRX cycle is not started as specified;
(ii) if the MAC entity would not be in active time considering grants, assignments, DRX command MAC CE, long DRX command MAC CE received, and scheduling request sent until 4-ms prior to symbol n when evaluating all DRX active time conditions as specified; AND if “allowCSI-SRS-Tx-MulticastDRX-Active” is not configured, or if “cfr-ConfigMulticast” is not configured for any of the active BWP(s) of the serving cell(s), or if all multicast DRXes would not be in active time considering multicast assignments, DRX command MAC CE for multicast-broadcast services (MBS) multicast received until 4-ms prior to symbol n when evaluating all DRX active time conditions as specified and all multicast sessions are configured with multicast DRX, then:
(iii) (a) not transmit periodic sounding reference signals (SRS) and semi-persistent SRS defined; (b) not report semi-persistent CSI configured on physical uplink shared channel (PUSCH); and
(iv) if “ps-TransmitPeriodic L1-RSRP” is not configured with value true, then: not report periodic CSI that is L1-RSRP on physical uplink control channel (PUCCH); and
(v) if “ps-TransmitOtherPeriodicCSI” is not configured with value true, then not report periodic CSI that is not L1-RSRP on PUCCH.

From the above, if the following optional parameters “ps-TransmitPeriodicL1-RSRP” or “ps-TransmitOtherPeriodicCSI” are set to the value ‘True’ when DCP is configured for the UE, then the UE reports the corresponding CSI information regardless of whether the UE is in DRX active time, which will reduce the power saving gain of using the LR when configured. Thus, when the LR is configured for a UE and the LP-WUS is activated or enabled to replace the DCP in RRC_CONNECTED Mode, enhancements to limit or restrict CSI reporting is needed. In addition, enhancements to other types of CSI reporting are needed when LP-WUS monitoring is enabled to prevent frequent wake-up of the MR.

One prior-art solution is to replicate CSI reporting for when LR is configured and LP-WUS monitoring is activated/enabled in RRC_CONNECTED Mode, as is done in legacy. For example, periodic CSI reporting is activated/deactivated by the network when LP-WUS is activated in RRC_CONNECTED Mode by setting the parameters ps-TransmitPeriodicL1-RSRP and/or ps-TransmitOtherPeriodicCSI to the value ‘True’ or ‘False’ respectively. Although this may be easy to implement, it has certain disadvantages that may diminish the power saving gain offered by LR. The MR needs to frequently wake-up to transmit the CSI report even if the MR may not need to monitor for PDCCH (i.e. wake-up for DL reception). Hence, the present disclosure provides needed enhancements to CSI reporting mechanisms in the UE when the UE is configured to actively monitor for LP-WUS.

Aspects of the present disclosure are described in the context of a wireless communications system. The present disclosure enhances CSI reporting mechanisms in the UE when UE is configured to actively monitor for LP-WUS. In one embodiment, CSI reporting may be suspended by deactivating CSI reporting within the DCP configuration information element (“DCP-Config IE”) when LP-WUS is activated. As another example, CSI reporting may be suspended by defining a new LP-WUS configuration information element (“LPWUS-Config IE”) where CSI reporting parameters are no longer required.

In one embodiment, the present disclosure provides a new time threshold that may be configured on top of the periodicity defined in the CSI report configuration information element (“ReportConfig IE”) by the network to restrict the frequency of CSI reporting when LP-WUS monitoring is activated or enabled. As one example, the new time threshold may be implemented as one of a timer to transmit, a prohibit timer, or as a new parameter within the ReportConfig IE.

In another embodiment, the present disclosure provides a method to indicate skipping of CSI reporting occasions within the LP-WUS signal, allowing for increased sleep time of the MR. As one example, the method may be implemented by introducing two bits within the LP-WUS signal to indicate the skipping duration for CSI reporting.

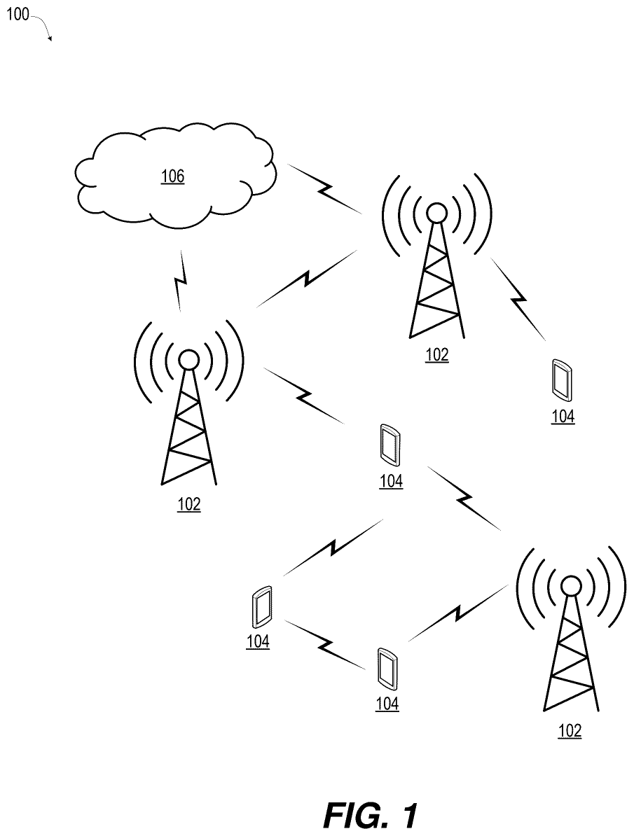

FIG. 1 illustrates an example of a wireless communications system 100 in accordance with aspects of the present disclosure. The wireless communications system 100 may include one or more network entity (NE) 102, one or more user equipment (UE) 104, and a core network (CN) 106. The wireless communications system 100 may support various radio access technologies. In some implementations, the wireless communications system 100 may be a fourth generation (4G) network, such as an LTE network or an LTE-Advanced (LTE-A) network. In some other implementations, the wireless communications system 100 may be a new radio (NR) network, such as a fifth generation (5G) network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communications system 100 may support radio access technologies beyond 5G, for example, 6G. Additionally, the wireless communications system 100 may support different technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be, or may include, or may be referred to as a network node, a base station, a network element, a network function, a network equipment, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME) and/or an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100, including time resources (e.g., symbols, slots, subframes, frames, or the like) or frequency resources (e.g., subcarriers, carriers) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing, a second numerology (e.g., μ=1), which includes 30 kHz subcarrier spacing, and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing, and a fourth numerology (e.g., μ=3), which includes 120 kHz subcarrier spacing.

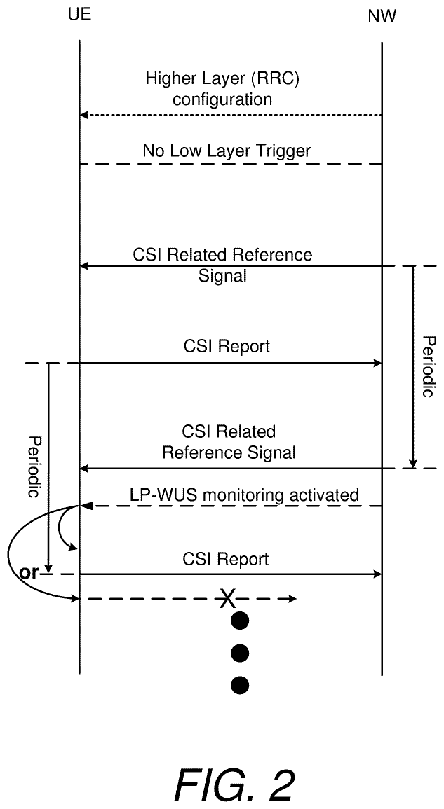

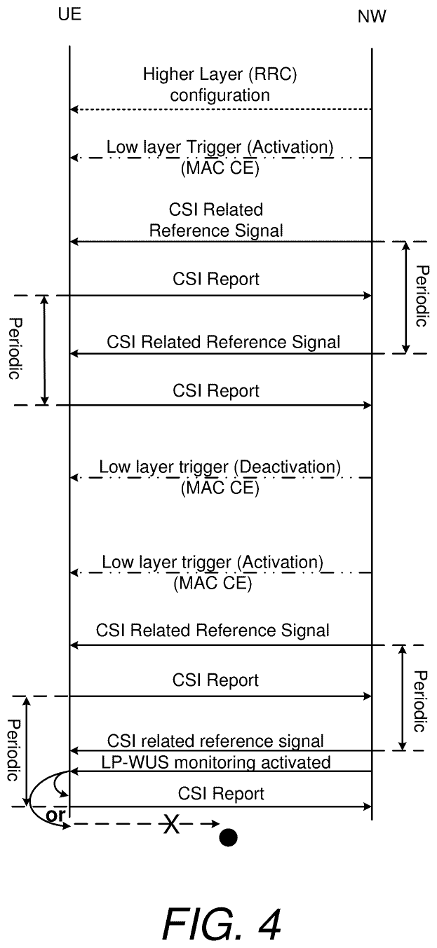

FIGS. 2-4 illustrate implementing LP-WUS with reduced reporting of channel state information for increased power savings at the UE, while continuing to support sufficient CSI reporting for successful communications in three different types of reporting, respectively, in accordance with aspects of the present disclosure. FIG. 2 is a timing diagram of periodic reporting with reduced reporting of channel state information for low-power wake-up radio (LP-WUR) mode in accordance with aspects of the present disclosure. Network (NW) transmits a higher layer (e.g., RRC) configuration to UE rather than sending a lower layer trigger. NW transmits CSI related reference signal(s). UE transmits a CSI report. The transmitting of the CSI related reference signal and the CSI report are according to a periodic schedule that the NW can cause to be skipped for power saving at the UE.

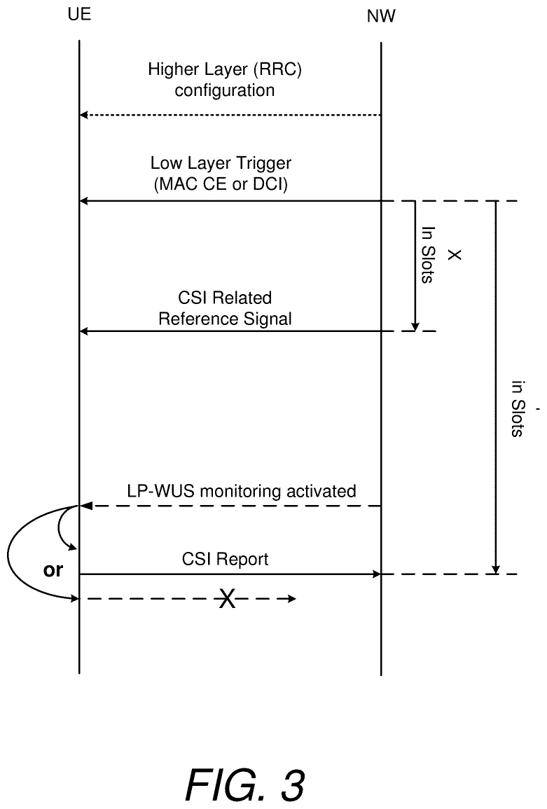

FIG. 3 is a timing diagram of aperiodic reporting with reduced reporting of channel state information for LP-WUR mode in accordance with aspects of the present disclosure. NNW transmits a higher layer (e.g., RRC) configuration to UE. NW transmits a lower layer trigger such as MAC CE or DCI to the UE. NW transmits CSI related reference signal(s) aperiodically in X slots. UE transmits a CSI report in Y slots. The transmitting of the CSI related reference signal and the CSI report are according to an aperiodic schedule prompted by the NW that the NW can cause to be skipped for power saving at the UE.

FIG. 3 is a timing diagram of semi-persistent reporting with reduced reporting of channel state information for LP-WUR mode in accordance with aspects of the present disclosure. NNW transmits a higher layer (e.g., RRC) configuration to UE. NW transmits a lower layer trigger such as MAC CE to the UE. NW transmits CSI related reference signal(s). After a discontinuation in the period, the NW can similarly initiate another series of semi-persistent periodic CSI reporting. NW can cause certain occasions of the semi-persistent periodic CSI reporting to be skipped for power saving at the UE.

Various different embodiments of the disclosure are provided herein each presenting a different process or methodology for reducing the reporting of the CSI and also reducing the need for waking up the MR to support the reporting of the CSI. In a first embodiment, referred to as Embodiment 1, a new LP-WUS configuration is provided.

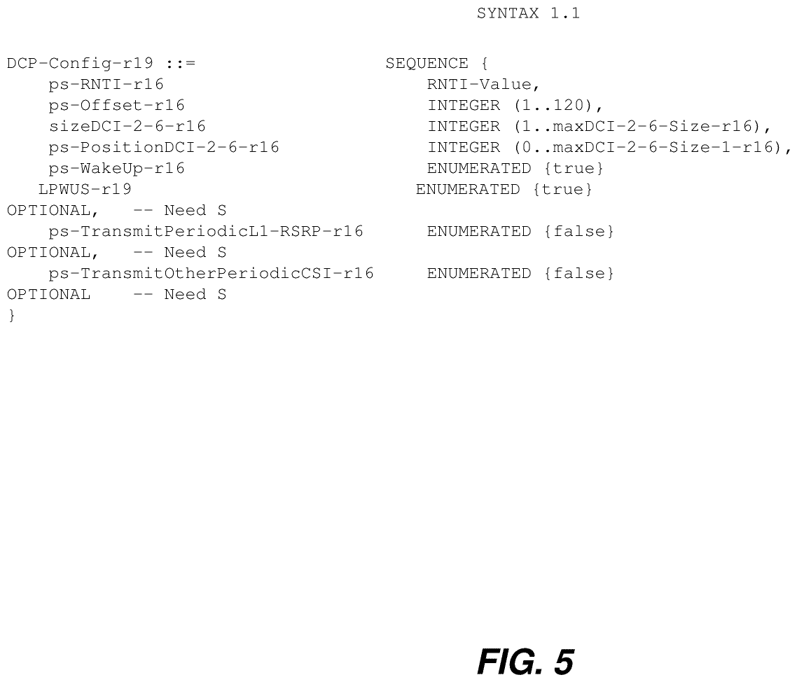

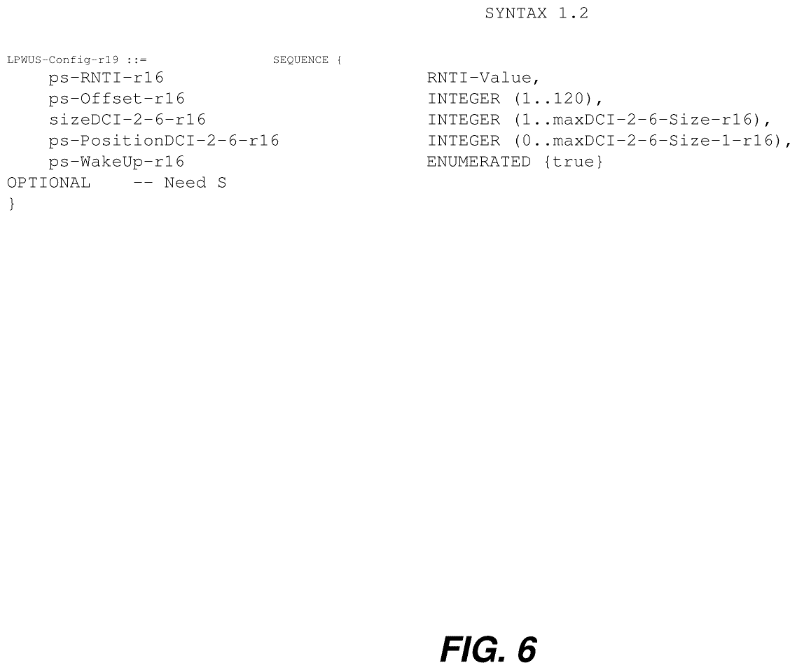

With embodiment 1, LP-WUS monitoring is enabled to replace the legacy DCP signal, and the LP-WUS is used to indicate whether the MR needs to wake-up and monitor PDCCH in the next DRX onDuration period. For this implementation (i.e., where LP-WUS replaces legacy DCP functionality and DRX is configured in RRC_CONNECTED Mode), a new LP-WUS configuration is provided that defines the LP-WUS signal. One exemplary syntax for the inclusion of a new parameter within the legacy DCP IE is depicted in FIG. 5, and another exemplary syntax of a new LP-WUS IE is shown in FIG. 6.

FIG. 5 is an example Syntax 1.1 for DCP information element that incorporates a new parameter for LP-WUR mode. In one implementation, the LP-WUS configuration could be mentioned as a new parameter within the legacy DCP Information Element (as shown in Syntax 1.1). This new parameter may take either of the enumerated values ‘true’ or ‘false’, indicating whether LP-WUS monitoring is enabled or disabled respectively. When this parameter value is ‘true’, the optional parameters for CSI reporting can either be always set to ‘False’ or these optional parameters may be ignored by the UE (i.e., the UE does not report periodic CSI on PUCCH regardless of whether the ps-TransmitPeriodicL1-RSRP and/or ps-TransmitOtherPeriodicCSI parameters are set to ‘True’ or not). Thus, the activation of the LP-WUS is treated as an implicit indication to disable/suspend the periodic reporting of CSI on PUCCH. The legacy procedure of reporting periodic CSI on PUCCH can be resumed when the LP-WUS signal is deactivated (i.e., the legacy DCP is used to wake-up the MR in the next DRX Active Time).

FIG. 6 is example Syntax 1.2 for a new information element for LP-WUR mode. In yet another implementation, the LP-WUS configuration could be a new Information Element by itself (e.g., LPWUS-Config-r19, as shown in Syntax 1.2). With this implementation, the CSI reporting may be restricted by not including the optional parameters for CSI Reporting in the new configuration. The legacy procedure of reporting periodic CSI on PUCCH can be resumed when the LP-WUS signal is deactivated (i.e., the legacy DCP is used to wake-up the MR in the next DRX Active Time).

By utilizing the two example syntaxes illustrated by the FIGS. 5 and 6, the MR can continue to sleep if the LP-WUS signal indicates that the UE need not wake up during the next DRX Active Time.

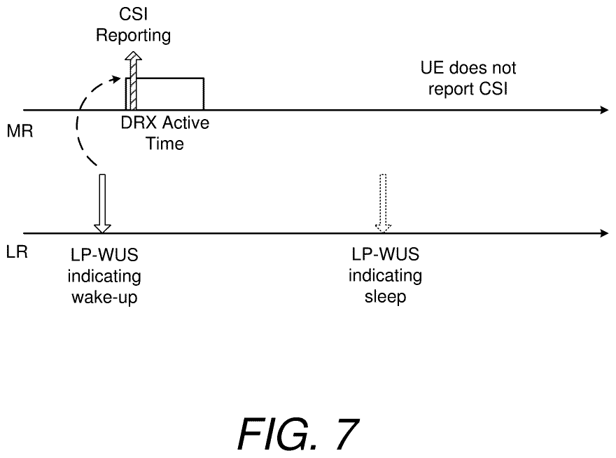

A second embodiment of the disclosure couples CSI Reporting with LP-WUS. FIG. 7 is a diagram of a communication activity for channel state information (CSI) reporting by a main radio and a lower power radio of a UE configured for LP-WUR mode in accordance with aspects of the present disclosure. This second embodiment involves altering the behavior of periodic CSI reporting on PUCCH when LR is configured and LP-WUS is activated to replace the DCP signal, such that the reporting of periodic CSI on PUCCH is coupled with the LP-WUS indication when such monitoring is activated or enabled. When the LP-WUS is used to inform the UE whether the UE needs to wake-up in the next DRX active time or not, the LP-WUS can be used as an implicit indication of whether CSI reporting needs to be done, provided that the ps-TransmitPeriodicLI-RSRP and/or ps-TransmitOtherPeriodicCSI parameters are set to the value ‘True’. That is, when the ps-TransmitPeriodicL1-RSRP and/or ps-TransmitOtherPeriodicCSI parameters are set to ‘True’, the UE only reports the corresponding CSI Report on PUCCH if the LP-WUS signal indicates a wake-up in the next DRX Active Time. If these optional parameters are set to the value ‘False’, the UE follows legacy behavior and does not report the periodic CSI reports on PUCCH if the next DRX onDuration would not be in Active Time.

A third embodiment provides restricted reporting of periodic CSI on PUCCH. In conventional applications, the periodic CSI report on PUCCH can be configured to be reported as frequently as every 2-ms which may significantly diminish the power saving gain of the LR if the MR needs to frequently wake up for such reporting. In this third embodiment, the UE is configured with a new time threshold (i.e., one specific to when LP-WUS is enabled/activated) to be used on top of the periodicity that is set for CSI reporting when legacy DCP is used. This new time threshold may be based on the mobility state of the UE, the power saving requirement, the coverage of LR and/or a combination of two or all of these factors, in order to restrict the periodic reporting of CSI on PUCCH. Thus, provided that the LR is configured for the UE and LP-WUS is activated to replace the DCP in Connected Mode DRX, the UE does not report periodic CSI on PUCCH even when the ps-TransmitPeriodicLI-RSRP and/or ps-TransmitOtherPeriodicCSI parameters are set to ‘True’, until and unless this time threshold is exceeded. The time threshold is configured by the network and restarted once a CSI report has been transmitted.

In one implementation, the timer is maintained as a timer until the CSI report is transmitted. With this implementation, the timer is configured by the network based on certain criteria such as the mobility state of the UE, the power saving requirement of the UE, the coverage of LR and/or a combination of two or all of these criteria. The timer is started after the transmission of a periodic CSI report on PUCCH, and upon expiry of the timer, the next periodic CSI report on PUCCH is transmitted. The timer may be configured either by RRC Configuration or may be maintained by the MAC layer.

In another implementation, the timer may be maintained as a prohibit timer. As a prohibit timer, the timer is configured by the network based on certain criteria such as the mobility state of the UE, the power saving requirement of the UE, the coverage of LR and/or a combination of two or all of these criteria. The timer is started upon the transmission of a periodic CSI report on PUCCH. While the timer is running, no periodic CSI reports are transmitted over PUCCH. Once the timer expires, the UE may once again transmit a periodic CSI report on PUCCH provided such a report is available.

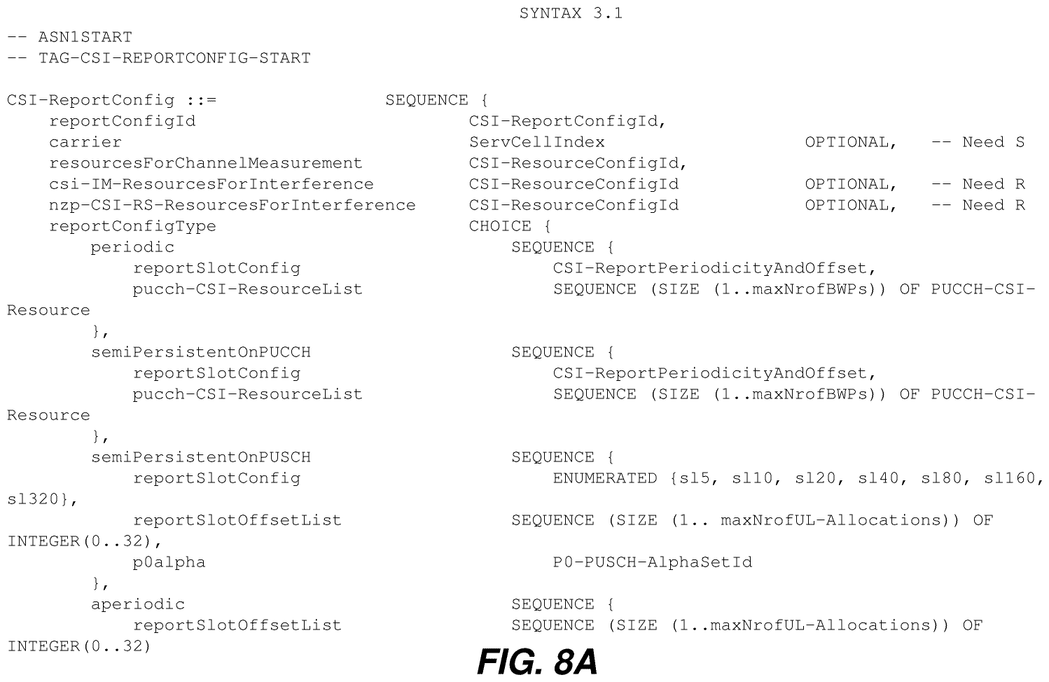

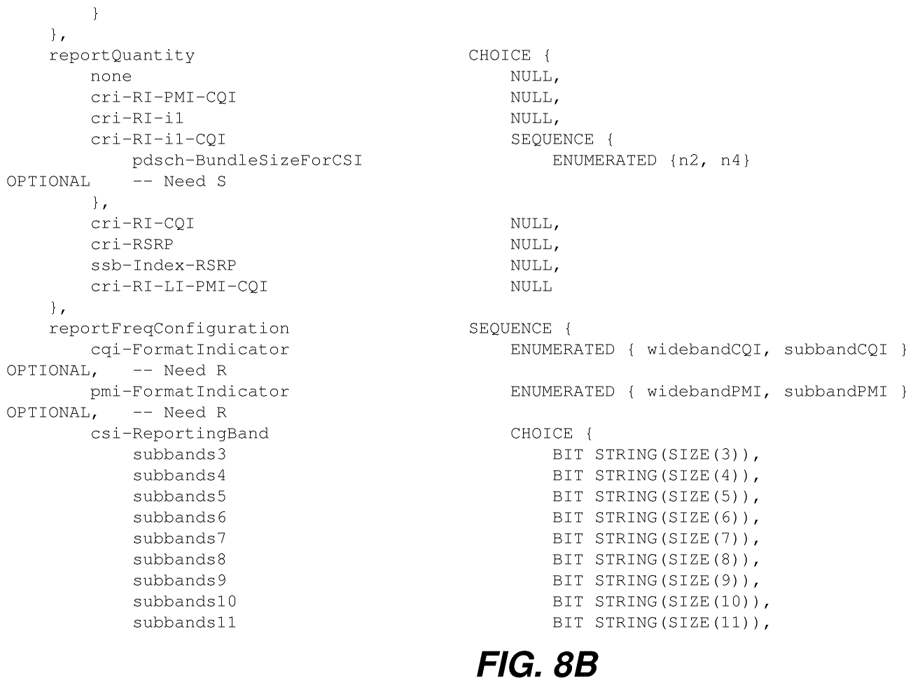

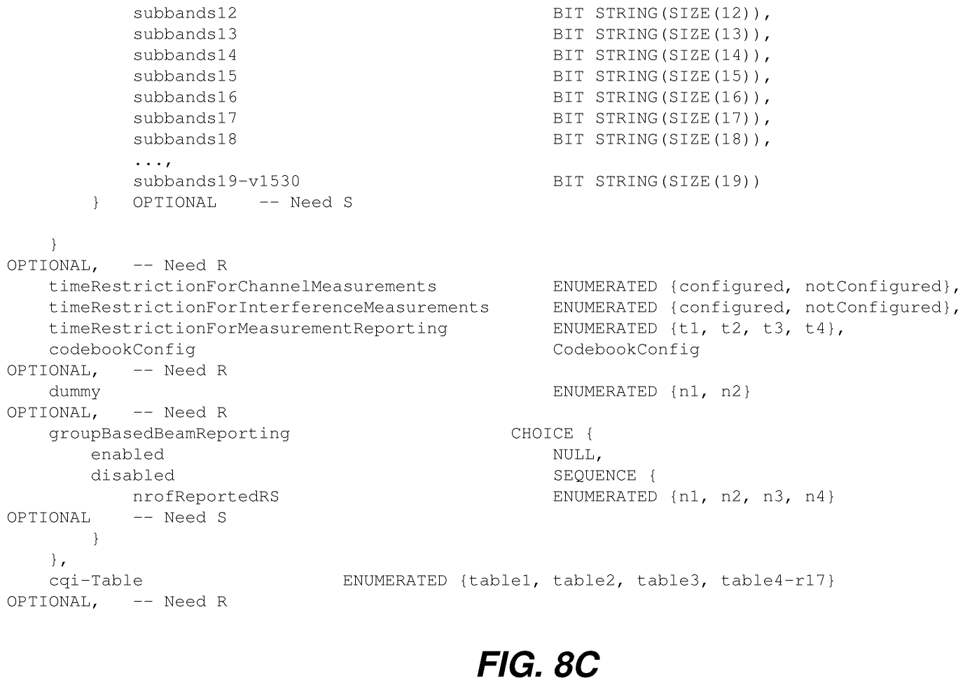

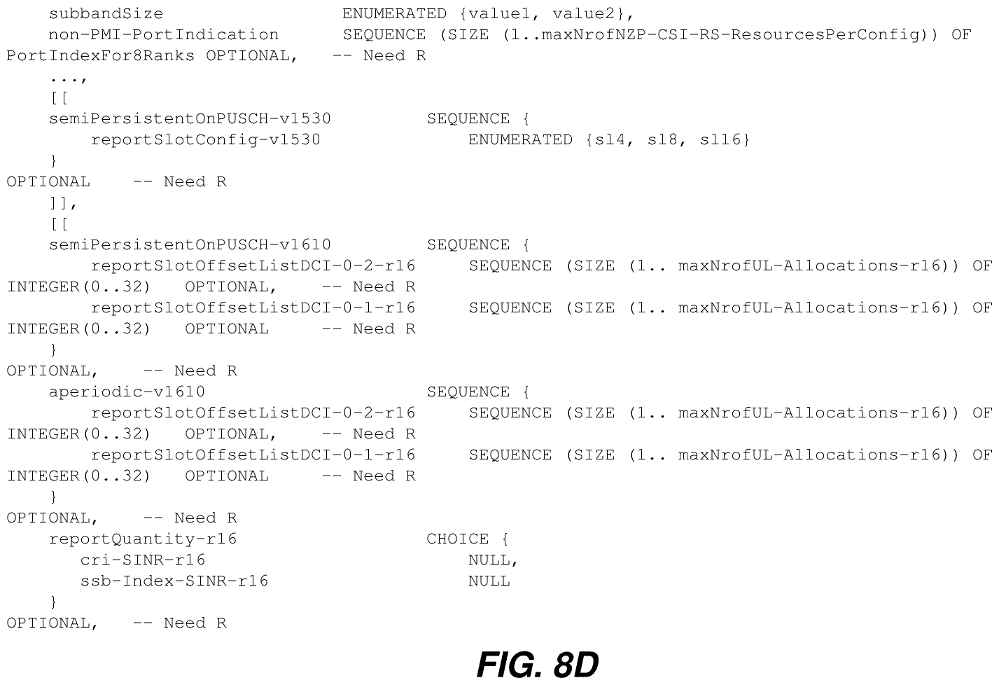

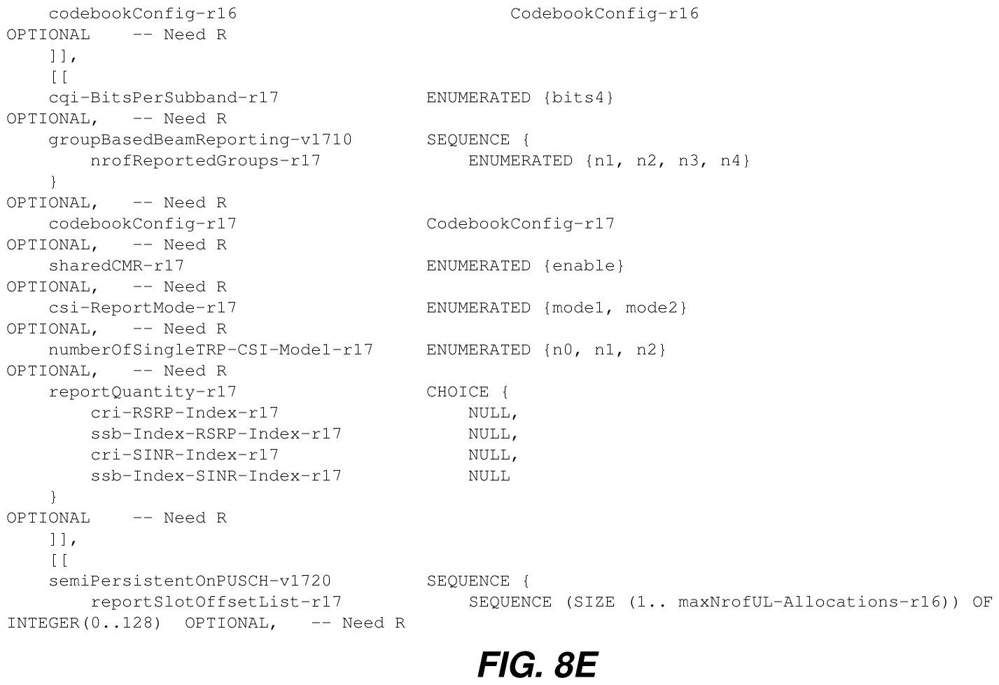

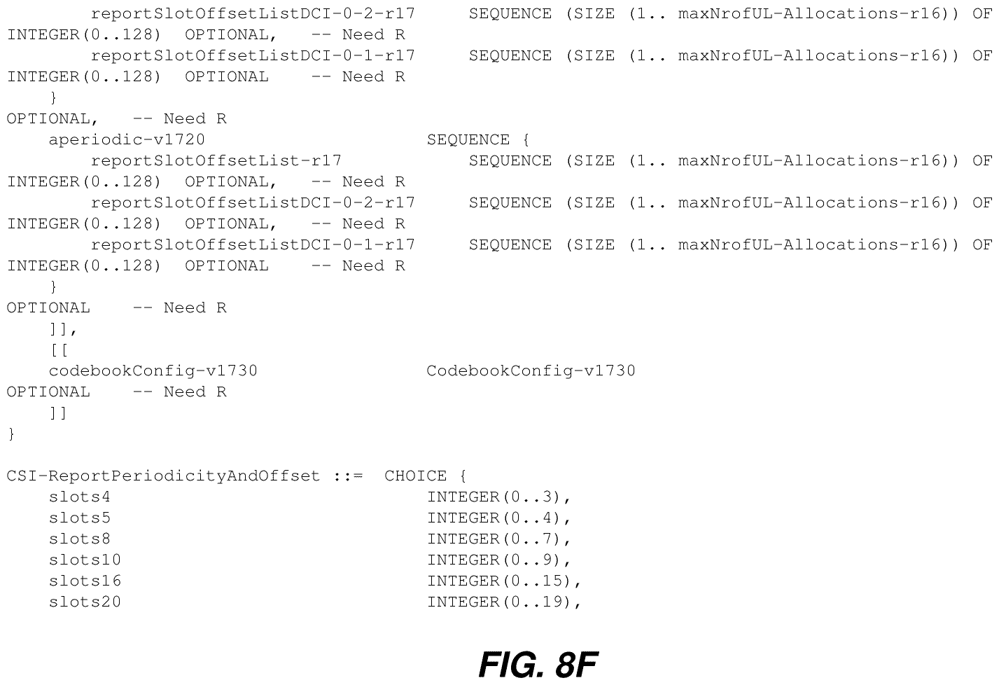

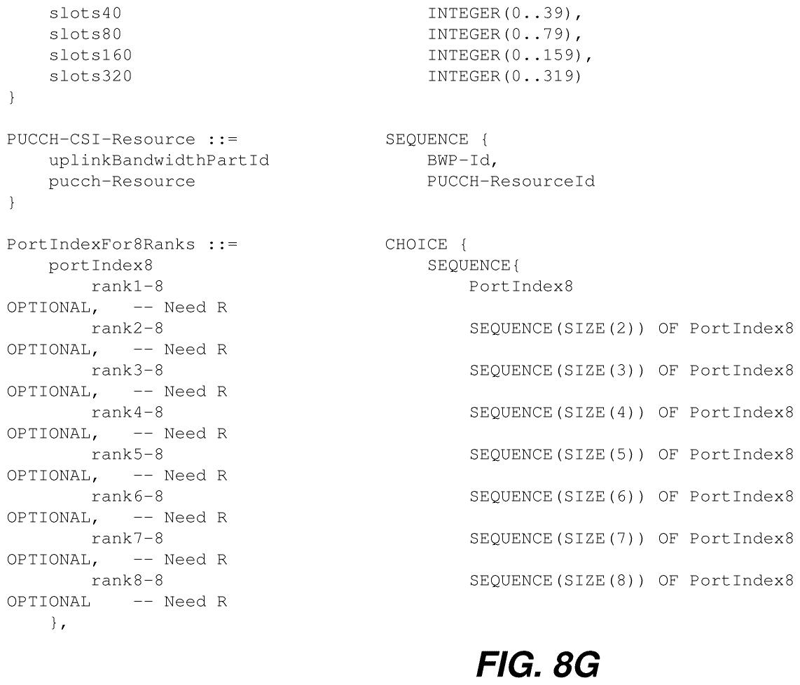

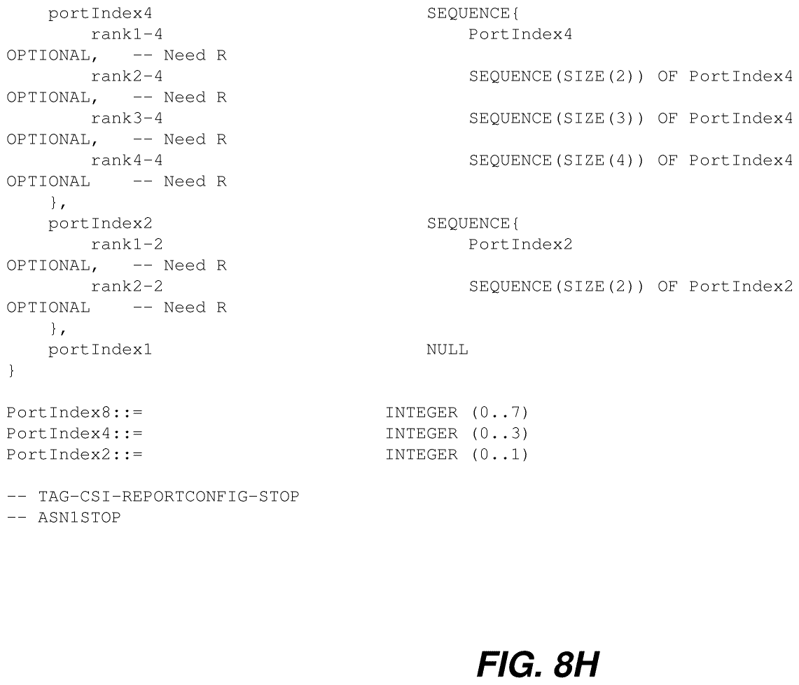

In yet another implementation of the third embodiment, a new RRC parameter ‘timeRestrictionForMeasurementReporting’ is introduced to limit how often the periodic CSI report is transmitted over PUCCH. When this parameter is configured, the parameter indicates a timer value (e.g., t1, t2, t3, or t4) that denotes how long the UE must wait before reporting the next periodic CSI report on PUCCH. The timer value may be chosen by the network based on the mobility state of the UE, the power saving requirement of the UE, the coverage of LR and/or a combination of two or all of these factors. FIGS. 8A-8H (collectively “FIG. 8”) present example Syntax 3.1 that introduces a new RRC parameter to limit how often the periodic CSI report is transmitted, in accordance with aspects of the present disclosure.

A fourth embodiment of the disclosure includes utilizing LP-WUS in conjunction with DCP. According to the fourth embodiment, another way that LP-WUS may be used when Connected Mode DRX is configured is by configuring the LP-WUS signal to be used in conjunction with the legacy DCP signal. When the LP-WUS signal is enabled to be used in conjunction with legacy DCP, the UE monitors for the LP-WUS, which indicates if the UE should then monitor for the legacy DCP in the next DCP monitoring occasion. With this implementation, CSI reporting may still need to be restricted in order to maximize the power saving gain offered by the LR.

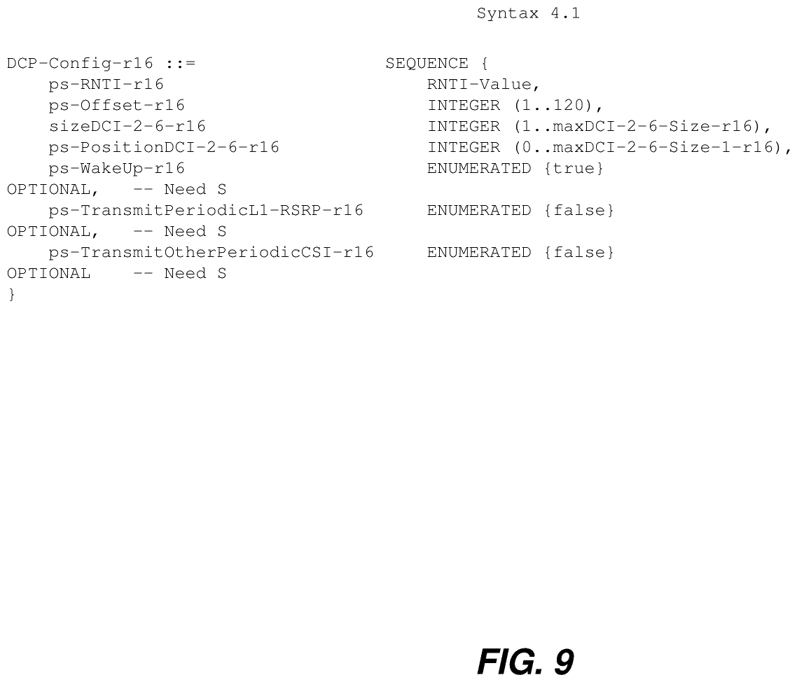

FIG. 9 provides example Syntax 4.1 for RRC connected mode including optional Boolean parameters that control LP-WUR mode, in accordance with aspects of the present disclosure. In this fourth embodiment, one solution is to set the optional parameters to Boolean value ‘False’ when LP-WUS monitoring is enabled in RRC_CONNECTED Mode, as depicted in Syntax 4.1. When these parameters are set to false, the UE does not report any periodic CSI Reports on PUCCH if the MR is not indicated, by the DCP signal, to monitor for PDCCH in the next DRX onDuration. In this way, the MR can continue to sleep if the DCP signal indicates that the UE need not wake up during the next DRX Active Time.

In one enhancement, the periodic reporting of CSI on PUCCH may also be coupled with the LP-WUS wake-up indication. That is, the UE only reports this periodic CSI measurements on PUCCH when the LP-WUS indicates that the UE must start monitoring for DCP and if the DCP signal indicates a wake-up in the next DRX onDuration Time. Otherwise, this report of CSI is not transmitted, allowing for continued sleep of the MR. In yet another implementation, the periodic CSI reporting on PUCCH may be limited by maintaining a threshold timer as defined above in the third embodiment.

A fifth embodiment of the disclosure provides utilizing LP-WUS for PDCCH skipping. When LP-WUS is used within the DRX onDuration, the LP-WUS is used to indicate which PDCCH occasions need to be monitored. That is, the LP-WUS is used to indicate whether an upcoming PDCCH occasion needs to be monitored or may be skipped, thus allowing for some power saving gain in that duration. In the instances where the LP-WUS indicates that the upcoming PDCCH occasion is to be skipped, the periodic reporting of CSI on PUCCH needs to be restricted to only those slots where MR is in active PDCCH monitoring.

In one implementation, the periodic CSI reporting on PUCCH may be coupled with the LP-WUS indication such that the LP-WUS is considered an implicit indication of whether the CSI report may be transmitted or not. When the LP-WUS indicates that the PDCCH monitoring occasion may be skipped, the UE does not transmit any periodic CSI report on PUCCH. If the LP-WUS indicates that the next PDCCH occasion may be actively monitored, the UE may transmit a CSI report (if available) in this occasion. In this way, the MR does not wake-up in any additional slots to transmit CSI reports, which prevents any additional power consumption by the UE.

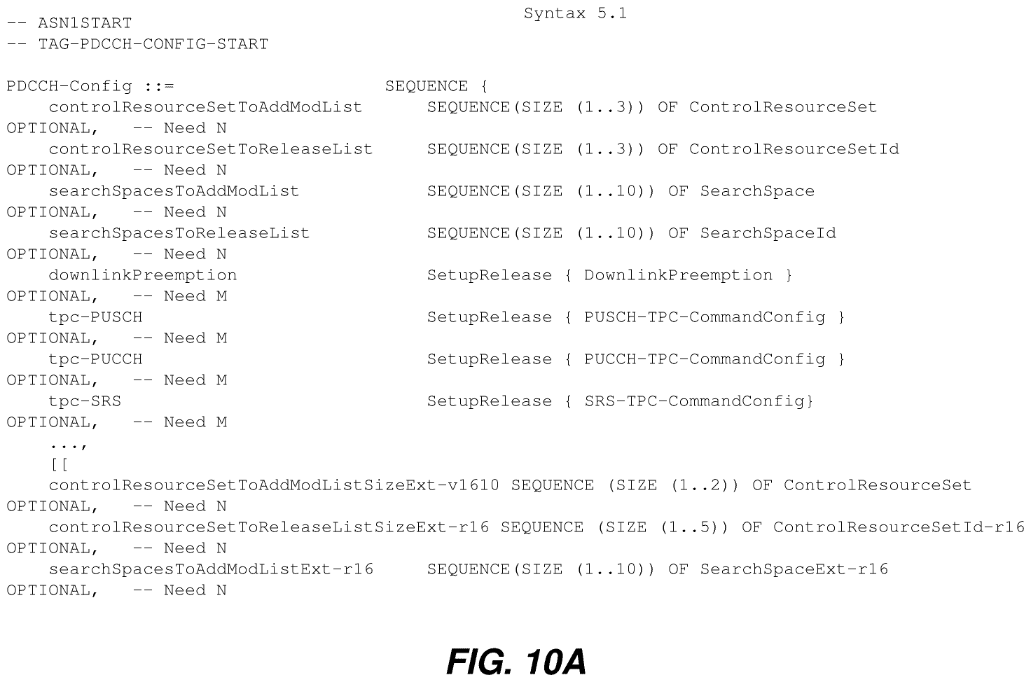

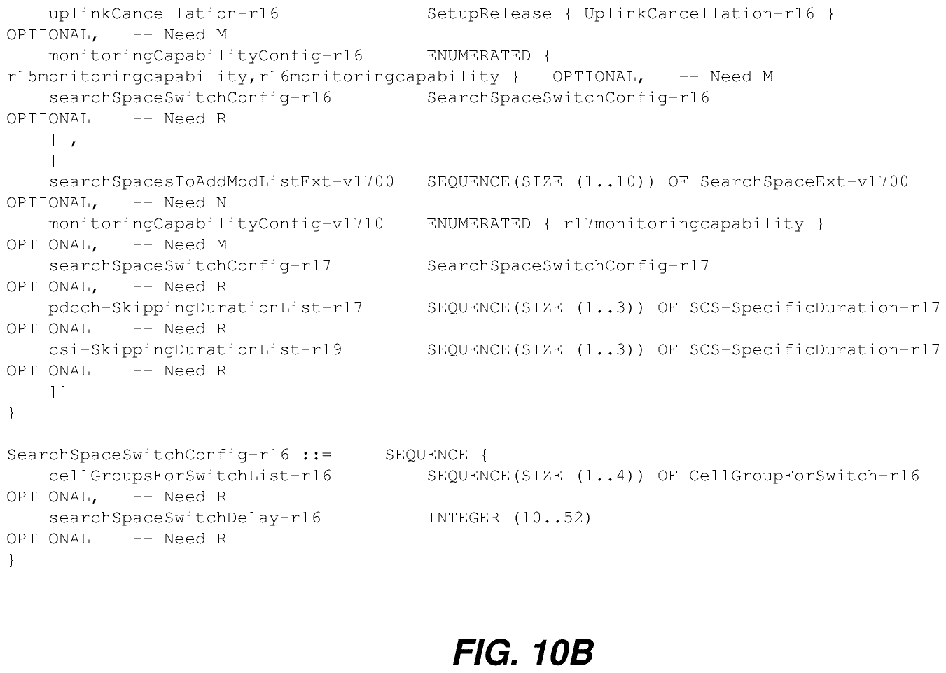

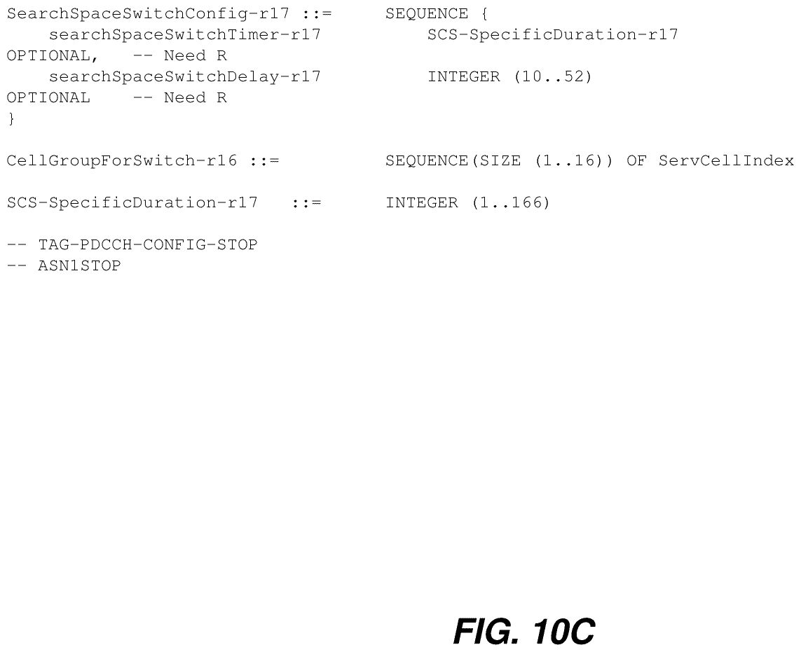

FIGS. 10A-10C (collectively “FIG. 10”) present Syntax 5.1 for an information element that carries explicit CSI reporting information in addition to physical downlink control channel (PDCCH) monitoring/skipping information in accordance with aspects of the present disclosure.

In another implementation of the fifth embodiment, the LP-WUS may carry some explicit CSI reporting information in addition to the PDCCH monitoring/skipping information. This information may either be a one-bit indication or a two-bit indication. If the LP-WUS signal carries one bit for CSI Reporting indication, the implementation may be modelled as an activation/de-activation of the CSI reporting, where a bit value ‘0’ indicates that a CSI report is not transmitted in the upcoming reporting occasion and a bit value ‘1’ indicates that the MR may transmit the CSI report in the next reporting occasion. In one enhancement to this implementation, if the CSI Reporting bit indicates a value ‘1’, the reporting may be further restricted to only those occasions where the LP-WUS indicates that PDCCH may be actively monitored.

Alternatively, if the LP-WUS signal carries this explicit CSI reporting information as two bits, the two bits may indicate the duration for which CSI reporting occasions may be skipped. The skipping duration, for example, may be based on a new parameter (e.g., csi-SkippingDurationList-r19) defined in the PDCCH-Config element. As an example, the two bits take the values ‘00’, ‘01’, ‘10’, and ‘11’, where these values indicate no skipping, skipping for a duration equivalent to the first value in the csi-SkippingDurationList-r19, skipping for a duration equivalent to the second value in the csi-SkippingDurationList-r19, or skipping for a duration equivalent to the third value in csi-SkippingDurationList-r19 respectively. If multiple durations are not provided in the csi-SkippingDurationList-r19, the values ‘10’ and/or ‘11’ may be taken as reserved. In yet another implementation, the periodic CSI reporting on PUCCH may be limited by maintaining a threshold timer as defined above in the third embodiment.

A sixth embodiment of the disclosure provides for the reduction in transmission of other non-periodic CSI reports. When LP-WUS monitoring is enabled in RRC_CONNECTED Mode, there may also be a need to restrict and/or limit the reporting of CSI reports other than the periodic reports transmitted on PUCCH (e.g., aperiodic reports and semi-persistent reports), in order to prevent the degradation of the power saving gain achieved by using the LR. In this sixth embodiment, the transmission of such reports may be limited by triggering such reports less frequently and/or by limiting/restricting the reporting itself.

In one implementation, the triggering of such reports may be reduced by limiting the frequency at which the network sends a lower layer trigger to the UE. That is, the trigger by a MAC CE or DCI signal to report CSI information may be limited and/or restricted based on the mobility state of the UE, the power saving requirement of the UE, the coverage of LR and/or a combination of two or all of these factors. As utilized herein, the mobility state of the UE refers to how fast or slow the UE may be moving, the power saving requirement refers to how urgently the UE needs to reduce power consumption (e.g., if the UE battery may already be low), and LR coverage may refer to the reference signal received power (RSRP) strength as measured by the LR. In this implementation, the criteria for CSI Request limitation (e.g., the mobility state or power saving requirement or LR coverage) is shared by the UE to the network either before LP-WUS is activated or when LP-WUS is activated, before the MR goes to sleep. In one example, when the LR is configured and activated to monitor for LP-WUS in RRC_CONNECTED Mode, the network only activates the semi-persistent reporting of CSI by means of a medium access control (MAC) control element (CE) when the UE's mobility is higher than a certain threshold or within a certain range. The mobility state information is shared to the network by means of some UE Assistance Information (UAI), to prevent the activation of such reporting too frequently.

In another implementation, the reporting of CSI may be restricted when the LR is configured and activated to monitor for LP-WUS by coupling the reporting with the wake-up indication in the LP-WUS, as defined above in the second and fifth embodiments. That is, CSI reports may only be transmitted in the slots where the LP-WUS signal indicates that the MR needs to wake up. Otherwise, CSI reports are not transmitted, even if triggered. In one enhancement, CSI reporting may be further time restricted when LP-WUS is enabled/activated as defined above in the third embodiment. That is, the solutions/enhancements defined in the embodiments above may also be applicable to Semi-Persistent CSI Reporting on PUCCH/PUSCH and aperiodic CSI Reporting to increase the sleep time of the MR.

A seventh embodiment of the disclosure provides for enabling the LR to perform some portions of CSI report measurement. The seventh embodiment limits or restricts the wake-up of the MR when LP-WUS is being monitored in RRC_CONNECTED Mode by offloading some of the CSI Measurements onto the LR to allow for prolonged sleep of MR when a CSI report is triggered. To trigger an ‘LR-CSI Report’ (i.e., a report that is based on CSI measurements made by the LR), the network first sends a CSI request to the UE. The UE then formulates the report based on measurements made by the LR, and finally the UE transmits this report.

In one implementation, the network may send the CSI request on a DCI signal to the MR, as per legacy behavior, and the MR then transfers this request to the LR using the inter-processor communication. Alternatively, the network may have a new CSI request that is LR specific, and the request is directly received by the LR. For example, the request may be a LP-WUS that is quasi co-location type D (QCL-D) with CSI-RS. Once the LR obtains this request and conducts the required measurements, the LR may either transfer these values to the MR using the inter-processor communication, after which the MR formulates the LR-CSI report, or the LR may formulate the LR-CSI report directly. When the report is ready, the MR may wake-up to transmit this report on an appropriate reporting occasion.

In another implementation, the reporting occasion may be based on the reporting restriction or limitation, as defined in the embodiments above, where the LR-CSI report is differentiated by means of a tag within the report. The tag may be a one-bit indication that denotes the current report to be an LR measured report. Or the reporting occasions for LR-CSI reports may be different to the reporting occasions of legacy CSI reports, such that the network may be implicitly aware of the report type based on the occasion the network received the report on.

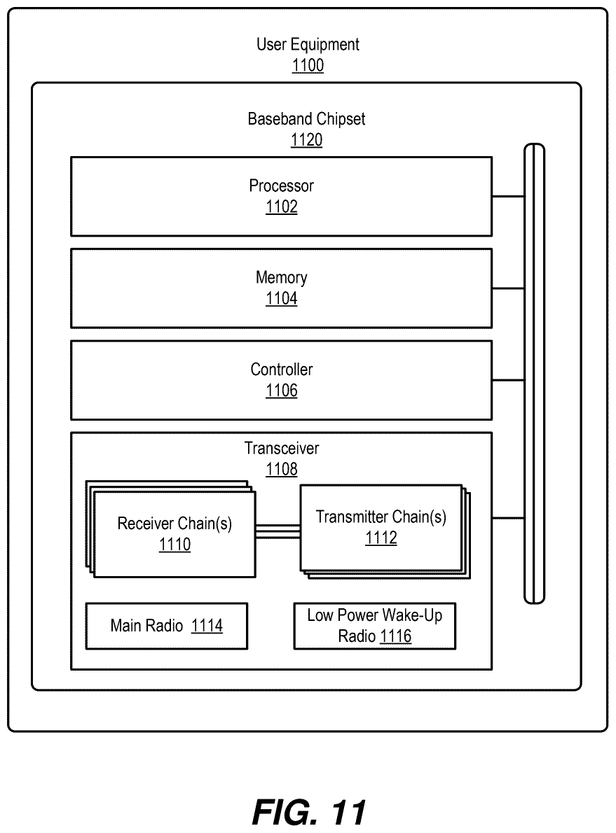

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to support a means for wireless communication that includes operating with either the main radio 1114 or the low power radio 1116 in support of channel state information (CSI) reporting.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof. A portion of the one or more receiver chains 1110 and the one or more transmitter chains 1112 are incorporated into a main radio 1114. Another portion of the one or more receiver chains 1110 and the one or more transmitter chains 1112 are incorporated into a low power radio 1116. The low power radio 1116 may have less communication performance capabilities than main radio 1114 but does consume a lower amount of power than main radio 1114. In support of CSI reporting, the lower power radio 1116 may be configured to be used as a LP-WUR that triggers wake up of the main radio 1114.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding and processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

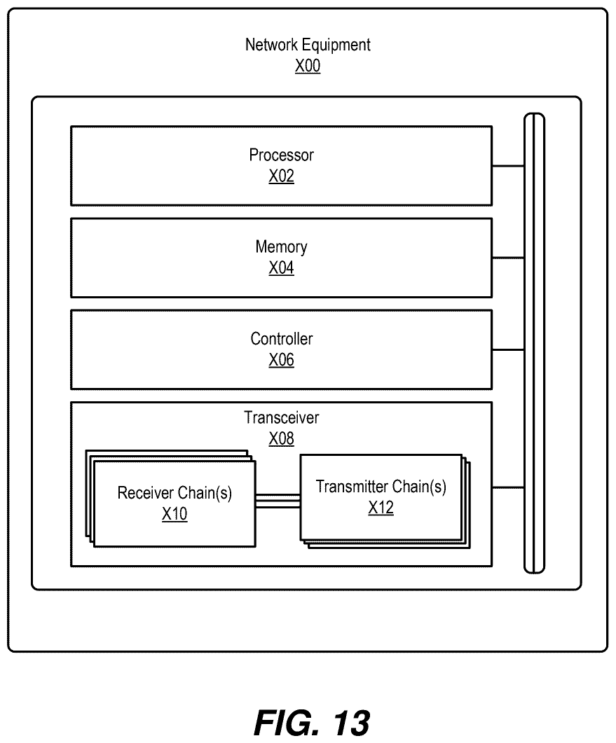

In one or more aspects of the present disclosure, the UE 1100 performs wireless communication via the transceiver 1108 including the main radio 1114 and the low power radio 1116. The UE 1100 includes at least one processor 1102 and at least one memory 1104. The at least one processor 1102 is coupled with the at least one memory 1104 and the transceiver 1108. The at least one processor 1102 is configured to cause the UE 1100, in response to configuring use of the low power radio 1114 to be a LP-WUR of the transceiver 1108, to perform the following: The UE 1100 initiates monitoring of a downlink from a network equipment 1300 (FIG. 13) for a low-power wake-up signal (LP-WUS) using the low power radio 1116. The UE 1100 receives a configuration for at least one CSI transmit condition of the UE 1100. In response to identifying that the CSI transmit condition is not satisfied, the UE 1100 continues monitoring the downlink for the LP-WUS using the low power radio 1116.

In one or more aspects of the present disclosure, in response to identifying that the at least one CSI transmit condition is satisfied, the UE 1100 may wake up the main radio 1114 to measure reference signals on the downlink. The UE 1100 generates a CSI report based on measurement of the reference signals. The UE 1100 transmits the CSI report to the network equipment 1300 (FIG. 13). In one or more particular embodiments, the UE 1100 tags the CSI report with information indicating measurement of the reference signals by the main radio 1114.

In one or more aspects of the present disclosures, the UE 1100 determines a next CSI reporting occasion associated with the main radio. The UE 1100 transmits the CSI report during the next CSI reporting occasion using the main radio 1114. In one or more aspects of the present disclosure, in response to the UE 1100 entering into the LP-WUS configuration, the at least one processor 1102 is configured to cause the UE 1100 to determine whether to report or not report the CSI based on a parameter contained within the LP-WUS configuration. In one or more particular embodiments, the UE 1100 wakes up the main radio 1114 for CSI reporting based on the parameter contained within the LP-WUS configuration being set to one of true/false. The user equipment does not wake up the main radio 1114 for CSI reporting based on the parameter contained within the LP-WUS configuration being set to the other false/true. In one or more particular embodiments, in response to the UE 1100 entering into the low-power wake-up signal configuration, the at least one processor 1102 is configured to cause the UE 1100 to not wake up the main radio 1114 for CSI reporting based on omission of CSI reporting parameters in the LP-WUS configuration.

In one or more aspects of the present disclosure, the LP-WUS configuration enables waking up the main radio 1114 for CSI reporting based on an indication within a received LP-WUS. The at least one processor 1102 is configured to cause the UE 1100 to, in response to receipt of the received LP-WUS, parse the LP-WUS for a parameter indicating whether to wake up or not to wake up the main radio 1114 for CSI reporting.

In one or more aspects of the present disclosure, the UE 1100 performs CSI reporting at a first periodicity (when not configured for use of LP-WUR). The UE 1100 identifies a time requirement of the LP-WUS configuration. The time requirement indicates an elapsed time since a last CSI report transmission before waking up the main radio 1114 for a next periodic CSI reporting. The UE 1100 implements the timer requirement to make the CSI reporting occur less often, to provide power conservation. In one or more particular embodiments, the UE 1100 implements the timer requirement based on one or more of a stored power state of the user equipment, a mobility rate of the user equipment, and power coverage of the UE 1100. In one or more particular embodiments, the UE 1100 implements the timer requirement as a time until transmit, which is configured by one of a radio resource control (RRC) configuration or maintained by medium access control (MAC) layer. In one or more particular embodiments, the UE 1100 implements the timer requirement as a prohibit timer that disables the CSI reporting until the prohibit timer expires. In one or more particular embodiments, the UE 1100 adjusts a duration of the timer requirement based on receiving a RRC parameter.

In one or more aspects of the present disclosure, in response to being configured for DRX, the UE 1100 determines whether the low-power wake-up signal indicates to monitor for downlink control information of power saving (DCP) signal during a next DCP monitoring occasion, with CSI reporting contingent upon DCP monitoring occurring. In one or more particular embodiments, the UE 1100 determines, based on DCP monitoring, whether or not a DCP signal indicates a wake-up of the main radio during a next DRX onDuration Time. In response to determining that the DCP signal does not indicate a wake-up of the main radio during a next DRX onDuration Time, the UE 1100 does not wake up the main radio for CSI reporting.

In one or more aspects of the present disclosure, the UE 1100 maintains a timer since a last transmission of a CSI report. In response to being configured for DRX, the UE 1100 determines whether the LP-WUS configuration indicates to monitor for a DCP signal during a next DCP monitoring occasion, with CSI reporting contingent upon DCP monitoring occurring. In response to generating a CSI report, the UE 1100 wakes-up the main radio to transmit the CSI report based on the timer. In one or more particular embodiments, the UE 1100 implements the timer as a time until transmit that is configured by one of a RRC configuration or maintained by medium access control (MAC) layer. In one or more particular embodiments, the UE 1100 implements the timer as a prohibit timer that disables the CSI reporting until the prohibit timer expires. In one or more particular embodiments, the UE 1100 adjusts a duration of the timer requirement based on receiving a RRC parameter.

In one or more aspects of the present disclosure, the UE 1100 determines, based on an indication in the low-power wake-up signal, whether an occasion of physical downlink control channel (PDCCH) is to be monitored by waking up the main radio. The restriction of monitoring the PDCCH implicitly indicates a restriction of CSI reporting on physical uplink control channel (PUCCH) or on Physical Uplink Shared Channel (PUSCH) to slots corresponding to PDCCH monitoring.

In one or more aspects of the present disclosure, the UE 1100 determines, based on an indication in the low-power wake-up signal, of an occasion of the PDCCH that is not to be monitored and explicitly whether CSI reporting on PUUCH or on PUSCH to slots corresponding to PDCCH monitoring are explicitly to be skipped or are allowed. In one or more particular embodiments, the UE 1100 determines, based on the LP-WUS, a number of occasions of CSI reporting on the PUCCH or PUSCH that are explicitly to be skipped.

In one or more aspects of the present disclosure, the UE 1100 transmits an aperiodic CSI report to the network equipment 1300 (FIG. 13). In one or more aspects of the present disclosure, the UE 1100 transmits a semi-persistent CSI report to the network equipment 1300 (FIG. 13). In one or more aspects of the present disclosure, the UE 1100 transmits, via the transceiver 1108 to the network equipment 1300 (FIG. 13), user equipment assistance information including at least one of power state, mobility state, and low-power coverage of the UE 1100 to prompt the network equipment 1300 (FIG. 13) to schedule CSI report less frequently.

In one or more aspects of the present disclosure, in response to identifying that the CSI transmit condition is satisfied, the UE 1100 measures reference signals on the downlink using the low power radio 1116. The UE 1100 generates a CSI report based on measurement of the reference signals. The UE 1100 wakes up the main radio 1114, and the UE 1100 transmits the CSI report to the network equipment 1300 (1300) using the main radio 1114. In one or more particular embodiments, the UE 1100 receives a CSI request using the main radio 1114. The UE 1100 transfers the CSI request to the low power radio 1116 via inter-processor communication. In one or more particular embodiments, the UE 1100 identifies a CSI request contained in the low-power wake-up radio signal by the low power radio 1116. In one or more particular embodiments, the UE 1100 tags the CSI report with information that indicates measurement of the reference signals by the low power radio 1116. In one or more particular embodiments, the UE 1100 determines a next CSI reporting occasion associated with the low power radio 1116. The UE 1100 transmits the CSI report during the next CSI reporting occasion using the low power radio 1116.

In one or more aspects of the present disclosure, the UE 1100 supports wireless communication and includes the transceiver having the main radio 1140 and the low power radio 1160. The UE 1100 includes the at least one memory 1104. The UE 1100 includes the at least one processor 1102 coupled with the transceiver 1108 and the at least one memory 1104. The at least one processor 1102 is configured to cause the UE 1100 to, in response to configuring the low power radio 1116 for use as a low-power wake-up radio of the transceiver 1108: (i) initiate monitoring of a downlink from the network equipment 1300 (FIG. 13) for a low-power wake-up signal using the low power radio 1116; (ii) receive a wake-up indication within the LP-WUS; (iii) identify from the wake-up indication whether the main radio (MR) needs to be woken up; and (iv) identify from the LP-WUS if channel state information needs to be reported based at least on one or more channel state information reporting conditions and/or configurations.

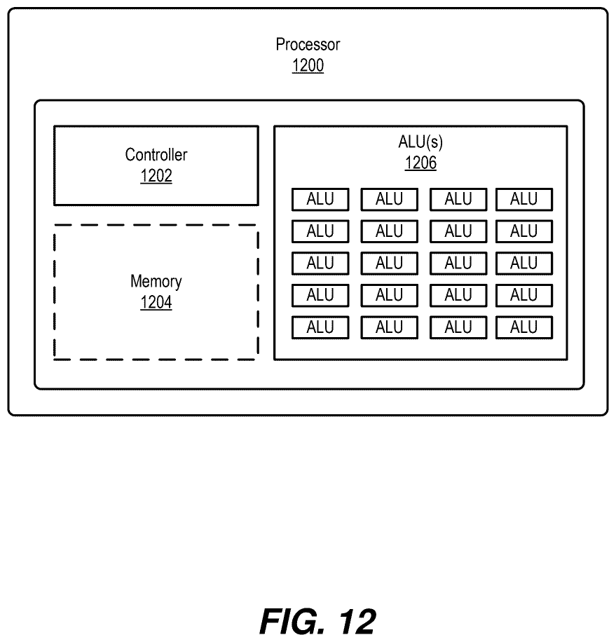

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading), in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with, or to, the memory 1204, and the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 are configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support a means for configuring the UE 1100 (FIG. 11) to perform LP-WUR using the low power radio 1116 to wake up the main radio 1114 for CSI reporting at a reduced number of occurrences for power savings. A certain number of CSI reports may be retained to ensure communication coverage for the UE 1100 (FIG. 11).

With continued reference to FIG. 11, according to aspects of the present disclosure, the UE 1100 implements the processor 1102, memory 1104, controller 1106 and transceiver 1108 as a baseband chipset 1120 that performs the functionality described herein. In one or more aspects of the present disclosure, the baseband chipset 1120 of the UE 1100 supports wireless communication and includes the transceiver having the main radio 1140 and the low power radio 1160. The baseband chipset 1120 includes the at least one memory 1104. The baseband chipset 1120 includes the at least one processor 1102 coupled with the transceiver 1108 and the at least one memory 1104. The baseband chipset 1120 is configured to cause the UE 1100 to, in response to configuring the low power radio 1116 for use as a low-power wake-up radio of the transceiver 1108: (i) initiate monitoring of a downlink from the network equipment 1300 (FIG. 13) for a low-power wake-up signal using the low power radio 1116; (ii) receive a wake-up indication within the LP-WUS; (iii) identify from the wake-up indication whether the main radio (MR) needs to be woken up; and (iv) identify from the LP-WUS if channel state information needs to be reported based at least on one or more channel state information reporting conditions and/or configurations.

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure, as described herein. These components may be coupled (e.g., operatively, communicatively, functionally, electronically, electrically) via one or more interfaces (not expressly shown).

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to support a means for configuring the UE 1100 (FIG. 11) to use the low power radio 1116 (FIG. 11) as a LP-WUR to wake up the main radio 1114 (FIG. 11) for CSI reporting, less frequently than conventionally done, in order to conserve UE power.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receive the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

According to aspects of the present disclosure, the at least one processor may further configure the network equipment to receive user equipment assistance information associated with the user equipment. The at least one processor compares the user equipment assistance information to a corresponding one or more criterion threshold of the at least one criterion to determine whether the user equipment satisfies the at least one criterion for reduced reporting of channel state information.

According to aspects of the present disclosure, the user equipment assistance information may include a stored power state of the user equipment. According to aspects of the present disclosure, the user equipment assistance information may include a mobility rate of the user equipment. According to aspects of the present disclosure, the user equipment assistance information may include power coverage with the user equipment. According to aspects of the present disclosure, the at least one processor configures the network equipment to communicate the indication to the user equipment to skip at least one occurrence of waking up the main radio for transmitting the channel state information report using a Boolean flag set to one of true/false. The at least one processor configures the network equipment to communicate an indication to the user equipment to wake up the main radio for transmitting the channel state information report using the Boolean flag set to the other one of false/true.

According to aspects of the present disclosure, the at least one processor configures the network equipment to communicate the indication to the user equipment to skip a defined number of occurrences of waking up the main radio. According to aspects of the present disclosure, the at least one processor configures the network equipment to communicate the indication to the user equipment to skip at least one occurrence of waking up the main radio for transmitting the channel state information report by configuring a timer requirement at the user equipment that imposes a minimum time between transmission of a channel state information report by the main radio of the user equipment. According to aspects of the present disclosure, the at least one processor configures the network equipment to configure the timer requirement by: (i) determining a duration of the timer requirement based on at least one assistance requirement of the user equipment from among a group comprising a stored power state, a mobility rate, and power coverage; and (ii) communicating the duration of the timer requirement to the user equipment.

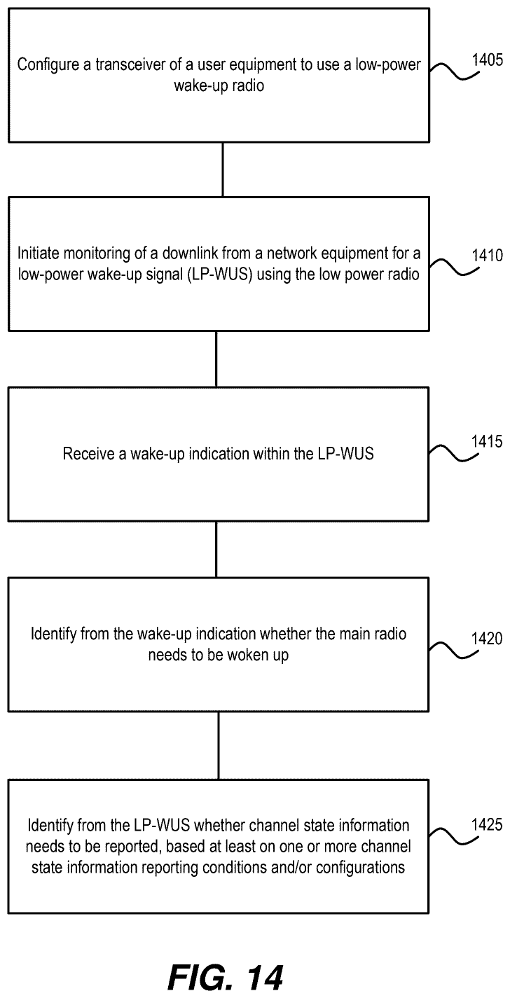

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1405, the method may include configuring a transceiver of a user equipment to use a low-power wake-up radio with a main radio in a sleep mode. The operations of 1405 may be performed in accordance with examples as described herein. In some implementations, aspects of the operations of 1405 may be performed by a UE as described with reference to FIG. 11.

At 1410, the method may include initiating monitoring of a downlink from a network equipment for a low-power wake-up signal using the low power radio. The operations of 1410 may be performed in accordance with examples as described herein. In some implementations, aspects of the operations of 1410 may be performed by a UE as described with reference to FIG. 11.

At 1415, the method may include receiving a wake-up indication within the LP-WUS. The operations of 1415 may be performed in accordance with examples as described herein. In some implementations, aspects of the operations of 1415 may be performed a UE as described with reference to FIG. 11.

At 1420, the method may include, identifying from the wake-up indication whether the main radio (MR) needs to be woken up. The operations of 1420 may be performed in accordance with examples as described herein. In some implementations, aspects of the operations of 1420 may be performed a UE as described with reference to FIG. 11.

At 1425, the method may include identifying from the LP-WUS if channel state information needs to be reported based at least on one or more channel state information reporting conditions and/or configurations. The operations of 1425 may be performed in accordance with examples as described herein. In some implementations, aspects of the operations of 1425 may be performed a UE as described with reference to FIG. 11.

According to aspects of the present disclosure, the method may further include configuring the transceiver of the user equipment to use the low-power wake-up radio with the main radio in a sleep mode. The method may further include receiving the configuration for the at least one channel state information transmit condition of the user equipment based on one or more of a low-power wake-up signal configuration associated with activation of the low-power radio to monitor for low-power wake-up signals and an indication provided within a received low-power wake-up signal. In response to identifying that the channel state information transmit condition is not satisfied, the method may further include continuing monitoring the downlink for the low-power wake-up signal using the low power.

According to aspects of the present disclosure, the method may further include, in response to identifying that the at least one channel state information (CSI) transmit condition is satisfied: (i) waking up the main radio to measure reference signals on the downlink; (ii) generating a CSI report based on measurement of the reference signals; and (iii) transmitting the CSI report to the network equipment. According to particular aspects of the present disclosure, the method may further include tagging the CSI report with information indicating measurement of the reference signals by the main radio. According to specific aspects of the present disclosure, the method may further include: (i) determining a next CSI reporting occasion associated with the main radio; and (ii) transmitting the CSI report during the next CSI reporting occasion using the main radio.

According to aspects of the present disclosure, the method may further include, in response to the user equipment entering into the low-power wake-up signal (LP-WUS) configuration, determining whether to report or not report the CSI based on a parameter contained within the LP-WUS configuration. According to particular aspects of the present disclosure, the method may further include: (i) waking up the main radio for CSI reporting based on the parameter contained within the LP-WUS configuration being set to one of true/false; and (ii) not waking up the main radio for CSI reporting based on the parameter contained within the LP-WUS configuration being set to the other one of false/truc. According to particular aspects of the present disclosure, the method may further include, in response to the user equipment entering into the low-power wake-up signal configuration, not waking up the main radio for CSI reporting based on omission of CSI reporting parameters in the LP-WUS configuration.

According to aspects of the present disclosure, the LP-WUS configuration enables waking up the main radio for CSI reporting based on an indication within a received LP-WUS. The method may further include, in response to receipt of the received LP-WUS, parsing the LP-WUS for a parameter indicating whether to wake up or not to wake up the main radio for CSI reporting.

According to aspects of the present disclosure, the method may further include: (i) performing CSI reporting at a first periodicity; (ii) identifying a timer requirement of the low-power wake-up signal (LP-WUS) configuration, the time requirement indicating an elapsed time since a last channel state information (CSI) report transmission before waking up the main radio for a next periodic CSI reporting; and (iii) implementing the timer requirement to make reporting less often of the CSI reporting for power conservation.

According to particular aspects of the present disclosure, the method may further include implementing the timer requirement based on one or more of a stored power state of the user equipment, a mobility rate of the user equipment, and power coverage of the user equipment. According to particular aspects of the present disclosure, the method may further include implementing the timer requirement as a time until transmit that is configured by one of a radio resource control (RRC) configuration or maintained by medium access control (MAC) layer.

According to particular aspects of the present disclosure, the method may further include implementing the timer requirement as a prohibit timer that disables the CSI reporting until the prohibit timer expires. According to particular aspects of the present disclosure, the method may further include adjusting a duration of the timer requirement based on receiving a radio resource control (RRC) parameter.

According to aspects of the present disclosure, the method may further include, in response to being configured for discontinuous reception (DRX), determining whether the low-power wake-up signal indicates to monitor for a DCP signal during a next DCP monitoring occasion, with CSI reporting contingent upon DCP monitoring occurring. According to particular aspects of the present disclosure, the method may further include, based on DCP monitoring, determining whether or not a DCP signal indicates a wake-up of the main radio during a next DRX onDuration Time; and, in response to determining that the DCP signal does not indicate a wake-up of the main radio during a next DRX onDuration Time, not waking up the main radio for CSI reporting.

According to aspects of the present disclosure, the method may further include maintaining a timer since a last transmission of a channel state information (CSI) report. The method may further include, in response to being configured for discontinuous reception (DRX), determining whether the low-power wake-up signal (LP-WUS) configuration indicates to monitor for a DCP signal during a next DCP monitoring occasion, with CSI reporting contingent upon DCP monitoring occurring. The method may further include, in response to generating a CSI report, waking up the main radio to transmit the CSI report based on the timer.

According to particular aspects of the present disclosure, the method may further include implementing the timer as a time until transmit that is configured by one of a radio resource control (RRC) configuration or maintained by medium access control (MAC) layer. According to particular aspects of the present disclosure, the method may further include implementing the timer as a prohibit timer that disables the CSI reporting until the prohibit timer expires. According to particular aspects of the present disclosure, the method may further include adjusting a duration of the timer requirement based on receiving a radio resource control (RRC) parameter.

According to aspects of the present disclosure, the method may further include determining, based on an indication in the low-power wake-up signal, whether an occasion of physical downlink control channel (PDCCH) is to be monitored by waking up the main radio, where restriction of monitoring the PDCCH implicitly indicates a restriction of CSI reporting on physical uplink control channel (PUCCH) or on Physical Uplink Shared Channel (PUSCH) to slots corresponding to PDCCH monitoring.

According to aspects of the present disclosure, the method may further include determining, based on an indication in the low-power wake-up signal, an occasion of the PDCCH that is not to be monitored and whether CSI reporting on physical uplink control channel (PUCCH) or on Physical Uplink Shared Channel (PUSCH) to slots corresponding to PDCCH monitoring are explicitly to be skipped or are allowed.

According to particular aspects of the present disclosure, the method may further include determining, based on the low-power wake-up signal, a number of occasions of channel state information (CSI) reporting on the PUCCH or PUSCH that are explicitly to be skipped. According to aspects of the present disclosure, the method may further include transmitting an aperiodic channel state information (CSI) report to the network equipment. According to aspects of the present disclosure, the method may further include transmitting a semi-persistent channel state information (CSI) report to the network equipment.

According to aspects of the present disclosure, the method may further include transmitting, via the transceiver to the network equipment, user equipment assistance information comprising at least one of power state, mobility state, and low-power coverage of the user equipment to prompt scheduling of less often reporting of channel state information (CSI) by the network equipment.

According to aspects of the present disclosure, the method may further include, in response to identifying that the channel state information (CSI) transmit condition is satisfied: (i) measuring reference signals on the downlink using the low power radio; (ii) generating a CSI report based on measurement of the reference signals; (iii) waking up the main radio; and (iv) transmitting the CSI report to the network equipment using the main radio. According to particular aspects of the present disclosure, the method may further include: (i) receiving a CSI request using the main radio; and (ii) transferring the CSI request to the low power radio via inter-processor communication. According to particular aspects of the present disclosure, the method may further include identifying a CSI request contained in the low-power wake-up radio signal by the low power radio. According to particular aspects of the present disclosure, the method may further include tagging the CSI report with information indicating measurement of the reference signals by the low power radio. According to specific aspects of the present disclosure, the method may further include: (i) determining a next CSI reporting occasion associated with the low power radio; and (ii) transmitting the CSI report during the next CSI reporting occasion using the low power radio.

It should be noted that the method described herein describes a possible implementation, and that the operations and the steps may be rearranged or otherwise modified and that other implementations are possible.

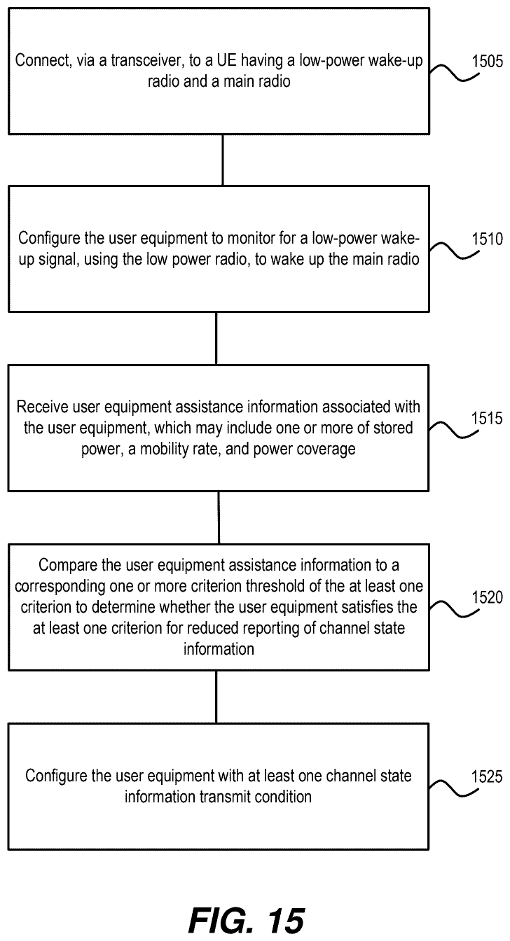

FIG. 15 illustrates a flowchart of a method in accordance with aspects of the present disclosure. The operations of the method may be implemented by a NE as described herein. In some implementations, the NE may execute a set of instructions to control the function elements of the NE to perform the described functions.

At 1505, the method may include connecting, via a transceiver, to a UE having a low-power wake-up radio and a main radio. The operations of 1505 may be performed in accordance with examples as described herein. In some implementations, aspects of the operations of 1505 may be performed by a NE as described with reference to FIG. 13.

At 1510, the method may include configuring the user equipment to monitor for a low-power wake-up signal, using the low power radio, to wake up the main radio. The operations of 1510 may be performed in accordance with examples as described herein. In some implementations, aspects of the operations of 1510 may be performed by a NE as described with reference to FIG. 13.

At 1515, the method may include receiving user equipment assistance information associated with the user equipment, which may include one or more of stored power, a mobility rate, and power coverage. The operations of 1515 may be performed in accordance with examples as described herein. In some implementations, aspects of the operations of 1515 may be performed a NE as described with reference to FIG. 13.

At 1520, the method may include comparing the user equipment assistance information to a corresponding one or more criterion threshold of the at least one criterion to determine whether the user equipment satisfies the at least one criterion for reduced reporting of CSI. The operations of 1520 may be performed in accordance with examples as described herein. In some implementations, aspects of the operations of 1520 may be performed by a NE as described with reference to FIG. 13.

At 1525, the method may include configuring the user equipment with at least one CSI transmit condition. The operations of 1525 may be performed in accordance with examples as described herein. In some implementations, aspects of the operations of 1525 may be performed by a NE as described with reference to FIG. 13.

In accordance with aspects of the present disclosure, the method may further include receiving user equipment assistance information associated with the user equipment. The method may further include comparing the user equipment assistance information to a corresponding one or more criterion threshold of the at least one criterion to determine whether the user equipment satisfies the at least one criterion for reduced reporting of channel state information. In accordance with aspects of the present disclosure, the user equipment assistance information includes a stored power state of the user equipment. In accordance with aspects of the present disclosure, the user equipment assistance information includes a mobility rate of the user equipment. In accordance with aspects of the present disclosure, the user equipment assistance information includes power coverage with the user equipment.

In accordance with aspects of the present disclosure, the method may further include communicating the indication to the user equipment to skip at least one occurrence of waking up the main radio for transmitting the channel state information report using a Boolean flag set to one of true/false. The method may further include communicating an indication to the user equipment to wake up the main radio for transmitting the channel state information report using the Boolean flag set to the other one of false/true.

In accordance with aspects of the present disclosure, the method may further include communicating the indication to the user equipment to skip a defined number of occurrences of waking up the main radio. In accordance with aspects of the present disclosure, the method may further include communicating the indication to the user equipment to skip at least one occurrence of waking up the main radio for transmitting the channel state information report by configuring a timer requirement at the user equipment that imposes a minimum time between transmission of a channel state information report by the main radio of the user equipment.

In accordance with particular aspects of the present disclosure, the method may further include configuring the timer requirement by: (i) determining a duration of the timer requirement based on at least one assistance requirement of the user equipment from among a group comprising a stored power state, a mobility rate, and power coverage; and (ii) communicating the duration of the timer requirement to the user equipment.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, the UE comprising:
a transceiver comprising a main radio and a low power radio;
at least one memory; and
at least one processor coupled with the transceiver and the at least one memory and configured to cause the UE to:
in response to configuring the low power radio for use as a low-power wake-up radio of the transceiver:
initiate monitoring of a downlink from a network equipment for a low-power wake-up signal (LP-WUS) using the low power radio;
receive a wake-up indication within the LP-WUS;
identify from the wake-up indication whether the main radio (MR) needs to be woken up; and
identify from the LP-WUS whether channel state information needs to be reported based at least on one or more channel state information reporting conditions and/or configurations.

2. The UE of claim 1, wherein the at least one processor is further configured to cause the UE to:
in response to identifying that the at least one channel state information (CSI) transmit condition is satisfied:
wake up the main radio to measure reference signals on the downlink;
generate a CSI report based on measurement of the reference signals; and
transmit the CSI report to the network equipment.

3. The UE of claim 2, wherein the at least one processor is further configured to cause the UE to:
determine a next CSI reporting occasion associated with the main radio; and
transmit the CSI report during the next CSI reporting occasion using the main radio.

4. The UE of claim 1, wherein in response to the UE entering into an LP-WUS configuration, the at least one processor is configured to cause the UE to determine whether to report or not report the channel state information (CSI) based on whether the LP-WUS was received or not.

5. The UE of claim 1, wherein in response to the UE entering into an LP-WUS configuration, the at least one processor is configured to cause the UE to determine whether to report or not report the channel state information (CSI) based on a parameter contained within the LP-WUS configuration.

6. The UE of claim 5, wherein:
the at least one processor is configured to cause the UE to wake up the main radio for CSI reporting based on the parameter contained within the LP-WUS configuration being set to one of true/false;
the at least one processor is configured to cause the UE to not wake up the main radio for CSI reporting based on the parameter contained within the LP-WUS configuration being set to the other false/true; and
the at least one processor is configured to cause the UE to not wake up the main radio for CSI reporting based on omission of CSI reporting parameters in the LP-WUS configuration.

7. The UE of claim 1, wherein an LP-WUS configuration enables waking up the main radio for CSI reporting based on an indication within a received LP-WUS, and the at least one processor is configured to cause the UE to, in response to receipt of the received LP-WUS, parse the received LP-WUS for a parameter indicating whether to wake up or not to wake up the main radio for CSI reporting.

8. The UE of claim 1, wherein the at least one processor is configured to cause the user equipment to:
perform CSI reporting at a first periodicity;
identify a timer requirement of the LP-WUS configuration, the time requirement indicating an elapsed time since a last channel state information (CSI) report transmission before waking up the main radio for a next periodic CSI reporting; and
implement the timer requirement to make reporting less often of the CSI reporting for power conservation.

9. The UE of claim 8, wherein the at least one processor is configured to cause the UE to implement the timer requirement based on one or more of a stored power state of the user equipment, a mobility rate of the user equipment, and power coverage of the user equipment.

10. The UE of claim 8, wherein the at least one processor is configured to cause the UE to implement the timer requirement as a time until transmit that is configured by one of a radio resource control (RRC) configuration or maintained by medium access control (MAC) layer.

11. The UE of claim 8, wherein the at least one processor is configured to cause the UE to implement the timer requirement as a prohibit timer that disables the CSI reporting until the prohibit timer expires.

12. The user equipment of claim 8, wherein the at least one processor is configured to cause the UE to adjust a duration of the timer requirement based on receiving a radio resource control (RRC) parameter.

13. The UE of claim 1, wherein the at least one processor is configured to cause the UE to:
determine, based on an indication in the low-power wake-up signal, whether an occasion of physical downlink control channel (PDCCH) is to be monitored by waking up the main radio, wherein restriction of monitoring the PDCCH implicitly indicates a restriction of CSI reporting on physical uplink control channel (PUCCH) or on Physical Uplink Shared Channel (PUSCH) to slots corresponding to PDCCH monitoring.

14. The UE of claim 1, wherein the at least one processor is configured to cause the UE to:
determine, based on an indication in the low-power wake-up signal, an occasion of the PDCCH that is not to be monitored and explicitly whether CSI reporting on physical uplink control channel (PUCCH) or on Physical Uplink Shared Channel (PUSCH) to slots corresponding to PDCCH monitoring are explicitly to be skipped or are allowed; and
determine, based on the low-power wake-up signal, a number of occasions of channel state information (CSI) reporting on the PUCCH or PUSCH that are explicitly to be skipped.

15. A baseband chipset for wireless communication, the baseband chipset comprising:
a transceiver comprising a main radio and a low power radio;
at least one memory; and
at least one processor coupled with the transceiver and the at least one memory, and configured to cause the baseband chipset to:
in response to configuring the low power radio for use as a low-power wake-up radio of the transceiver:
initiate monitoring of a downlink from a network equipment for a low-power wake-up signal (LP-WUS) using the low power radio;
receive a wake-up indication within the LP-WUS;
identify from the wake-up indication whether the main radio (MR) needs to be woken up; and
identify from the LP-WUS if channel state information needs to be reported based at least on one or more channel state information reporting conditions and/or configurations.

16. A method for wireless communication at a user equipment (UE), the method comprising:
configuring a transceiver of the UE to use a low-power wake-up radio;
initiating monitoring of a downlink from a base station for a low-power wake-up signal (LP-WUS) using the low power radio;
receiving a wake-up indication within the LP-WUS;
identifying from the wake-up indication whether the main radio (MR) needs to be woken up; and
identifying from the LP-WUS if channel state information needs to be reported based at least on one or more channel state information reporting conditions and/or configurations.

17. The method of claim 16, further comprising:
configuring the transceiver of the UE to use the low-power wake-up radio with the main radio in a sleep mode;
receiving a LP-WUS configuration associated with activation of the low-power wake-up radio to monitor for low-power wake-up signals and an indication provided within a received LP-WUS; and
in response to identifying that the channel state information transmit condition is not satisfied, continuing monitoring the downlink for the LP-WUS using the low power wake-up radio.

18. A base station for wireless communication, the base station comprising:
at least one memory; and
at least one processor coupled with the at least one memory, and configured to cause the base station to:
connect to a user equipment (UE) having a low-power wake-up radio and a main radio;
configure the UE to monitor for a low-power wake-up signal (LP-WUS), using the low power radio, to wake up the main radio; and
configure the UE with at least one channel state information transmit condition.

19. The base station of claim 18, wherein the at least one processor configures the base station equipment to:
receive user equipment assistance information associated with the user equipment, the user equipment assistance information comprising at least one of stored power state of the user equipment, a mobility rate of the user equipment, and power coverage with the user equipment; and
compare the user equipment assistance information to a corresponding one or more criterion threshold of at least one criterion to determine whether the user equipment satisfies the at least one criterion for reduced reporting of channel state information.

20. The base station of claim 18, wherein the at least one processor configures the base station to communicate the indication to the user equipment to skip at least one occurrence of transmitting the channel state information report using a Boolean flag set to one of true/false and to communicate an indication to the user equipment to transmit the channel state information report using the Boolean flag set to the other one of false/true.
